(19) United States
(12) Patent Application Publication
(10) Pub. No.: US 2011/0037775 A1
(43) Pub. Date: Feb. 17, 2011

(54) METHOD AND APPARATUS FOR CHARACTER INPUT USING TOUCH SCREEN IN A PORTABLE TERMINAL

(75) Inventors: Gwang-Ha PARK, Seoul (KR); Eui-Bum HAN, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/857,007

(22) Filed: Aug. 16, 2010

(30) Foreign Application Priority Data
Aug. 17, 2009 (KR) 10-2009-0075686

(51) Int. Cl. G06F 3/041; G09G 5/02

(52) U.S. Cl. 345/592; 345/467; 345/173

(57) ABSTRACT

A method and apparatus for character input using a touch screen in a portable terminal are provided. The method includes determining a character input mode when a screen is touched, displaying characters of the determined character input mode in peripheral regions centering on a touched position, and inputting a character positioned in a direction in which the touch is dragged.

### PRIORITY

This application claims the benefit under 35 U.S.C. §119(a) of a Korean patent application filed in the Korean Intellectual Property Office on Aug. 17, 2009 and assigned Serial No. 10-2009-0075686, the entire disclosure of which is hereby incorporated by reference.

### BACKGROUND OF THE INVENTION

1. Field of the Invention

The present invention relates to a method and apparatus for character input using a touch screen in a portable terminal. More particularly, the present invention relates to a method and apparatus for inputting a character according to the direction in which a touch screen is touched in a portable terminal.

2. Description of the Related Art

Recently, as portable terminals have become small in size, light weight, and slim, the convenience of carrying the portable terminals has increased and thus, the portable terminals have become a necessity. Thus, service providers (i.e., system manufacturers) have competitively developed portable terminals with more convenient functions to attract many users. More particularly, as many users prefer supplementary functions associated with a message such as a short message, a multimedia message, Electronic mail (E-mail), and a broadcasting message, to a telephone call function, the service providers have competitively developed portable terminals capable of efficiently inputting characters. For example, a Cheonjiin input scheme provides breaking vowels up into three elements of heaven (•), earth ( [symbol] ), and human ( [symbol] ), assigning the three elements to three keys, and assigning twenty one consonants to the remaining respective keys. However, the Cheonjiin input scheme is inconvenient in that a user needs to wait until the lapse of a predetermined time or input a direction key or a blank key for the sake of sequentially inputting several characters assigned to the same key.

Several methods for downsizing a keypad in the portable terminal have been recently provided with a miniaturization of the portable terminals. For one example, a scheme of displaying a keyboard on a touch screen without a separate keypad device and, when a user touches a corresponding character, inputting the touched character in a portable terminal has been provided. However, the character input scheme is a simple conversion of a scheme of inputting a character by pressing a key in the keypad device into a scheme of inputting a character by touching a preset region on the touch screen. Thus, the character input scheme has a disadvantage of the keypad device of the related art. In more detail, similarly to the character input scheme using the keypad device of the related art, the character input scheme using the touch screen in the portable terminal has a high probability to erroneously input unintended peripheral characters, and inputting a character is impossible until the touch screen is viewed. Also, the character input scheme using the touch screen is disadvantageous in that, in order to input one of several characters assigned to the same region, the user has to touch the same region several times. As a result, it is difficult to recognize whether a key is pressed because the user cannot feel or detect a key. Also, the character input scheme using the touch screen is disadvantageous in that, because a keyboard is fixed, the user has to accurately touch a corresponding region to input a character. Also, the character input scheme using the touch screen is an inconvenience because numeral, Hangeul, English, and Japanese input schemes are different from each other and the user has to learn each of the numeral, Hangeul, English, and Japanese input schemes.

Therefore, a need exists for a method and an apparatus for minimizing character inputs when using a touch screen in a portable terminal.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for character input using a touch screen in a portable terminal.

Another aspect of the present invention is to provide a method and apparatus for inputting a character according to the direction in which a touch screen is touched in a portable terminal.

A further aspect of the present invention is to provide a method and apparatus for integrating Hangeul, English, and Japanese input schemes in a portable terminal.

The above aspects may be achieved by providing a method and apparatus for character input using a touch screen in a portable terminal.

In accordance with an aspect of the present invention, a method for character input using a touch screen in a portable terminal is provided. The method includes determining a character input mode when a screen is touched, displaying characters of the determined character input mode in peripheral regions centering on a touched position, and inputting a character positioned in a direction in which the touch is dragged.

In accordance with another aspect of the present invention, an apparatus for character input using a touch screen in a portable terminal is provided. The apparatus includes a touch screen for detecting a touch by a user and displaying a character, and a controller for, when a screen is touched, determining a character input mode and display characters of the determined character input mode in peripheral regions centering on a touched position, and for controlling to input a character positioned in a direction in which the touch is dragged.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a portable terminal according to an exemplary embodiment of the present invention;

FIG. 2 is a flow diagram illustrating a character input procedure in a portable terminal according to an exemplary embodiment of the present invention;

FIGS. 3A and 3B are diagrams illustrating numeral keyboards of a related portable terminal and a portable terminal according to an exemplary embodiment of the present invention;

FIGS. 4A to 4C are diagrams illustrating a numeral input scheme in a portable terminal according to an exemplary embodiment of the present invention;

FIG. 5 is a diagram illustrating a numeral input and a touch operation corresponding to the input numeral in a portable terminal according to an exemplary embodiment of the present invention;

FIGS. 6A and 6B are diagrams illustrating an English keyboard of a portable terminal according to an exemplary embodiment of the present invention;

FIGS. 7A to 7D are diagrams illustrating an English character input scheme in a portable terminal according to an exemplary embodiment of the present invention;

FIGS. 8A and 8B are diagrams illustrating an English input and a touch operation corresponding to the English input in a portable terminal according to an exemplary embodiment of the present invention;

FIGS. 9A and 9B are diagrams illustrating a Hangeul keyboard in a portable terminal according to an exemplary embodiment of the present invention;

FIG. 10 is a diagram illustrating an extended Hangeul keyboard in a portable terminal according to an exemplary embodiment of the present invention;

FIGS. 11A to 11E are diagrams illustrating a Hangeul character input scheme in a portable terminal according to an exemplary embodiment of the present invention;

FIGS. 12A and 12B are diagrams illustrating a Japanese keyboard in a portable terminal according to an exemplary embodiment of the present invention;

FIGS. 13A and 13B are diagrams illustrating a Japanese keyboard in a portable terminal according to an exemplary embodiment of the present invention;

FIGS. 14A to 14F are diagrams illustrating a Japanese character input scheme in a portable terminal according to an exemplary embodiment of the present invention;

FIGS. 15A and 15B are diagrams illustrating Japanese character input schemes in a portable terminal of the related art and a portable terminal according to an exemplary embodiment of the present invention; and

FIGS. 16A and 16B are diagrams illustrating an input scheme for recognition rate extension in a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and apparatus for inputting a character according to the direction in which a touch screen is touched in a portable terminal.

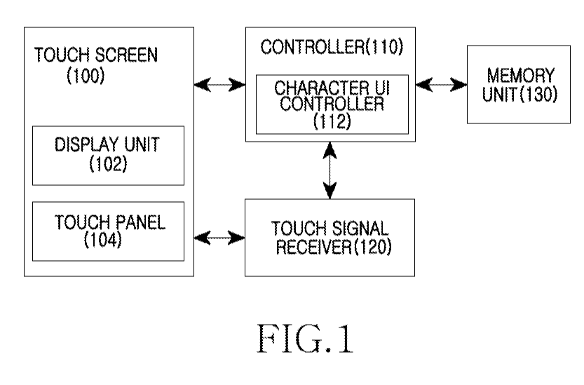

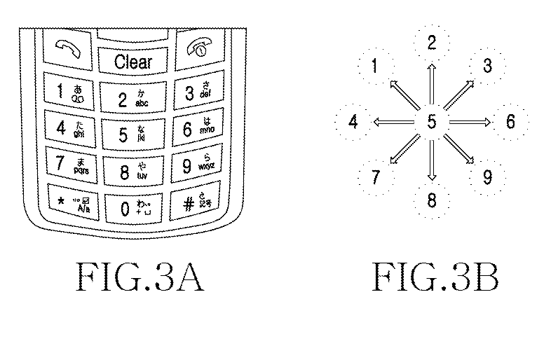

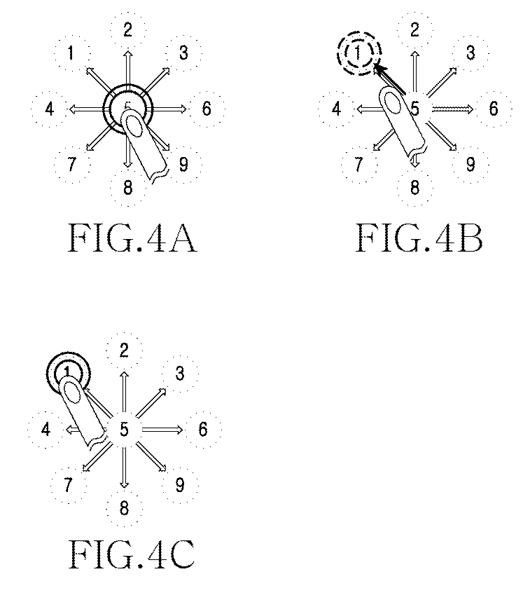

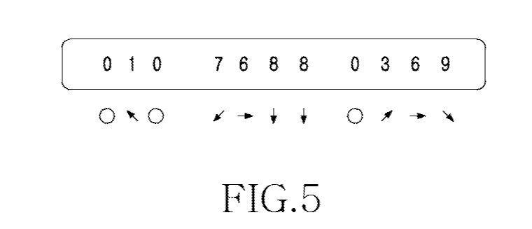

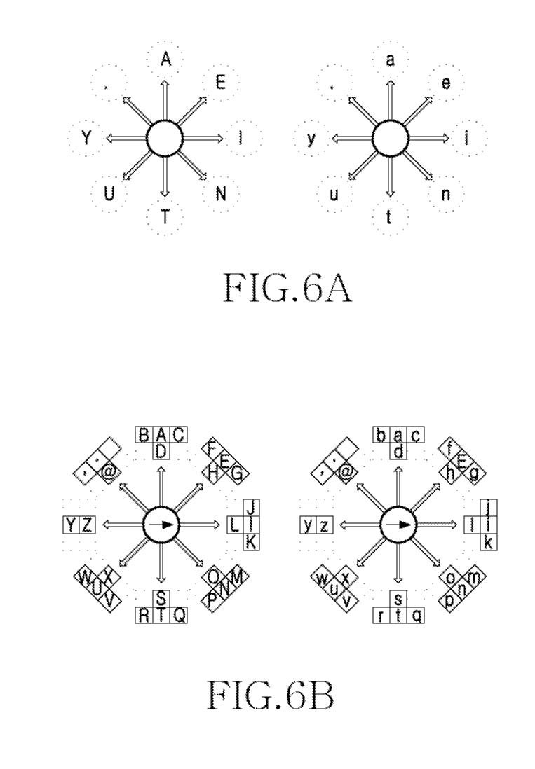

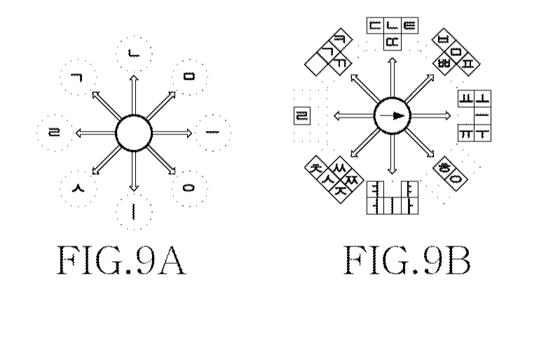

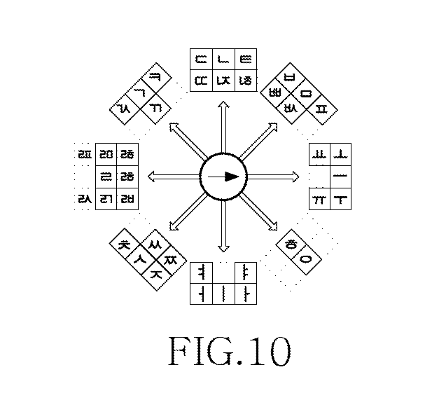

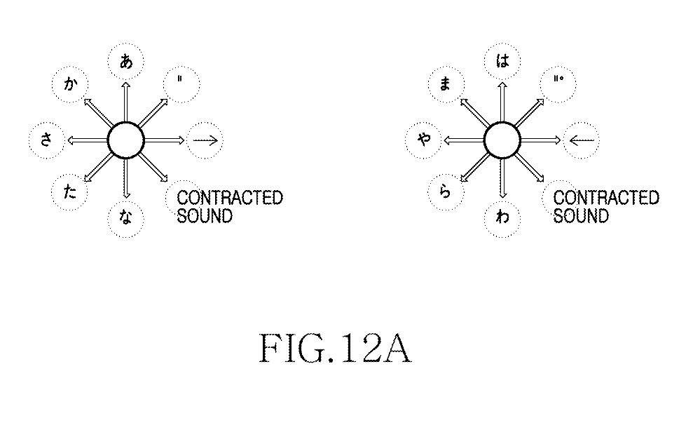

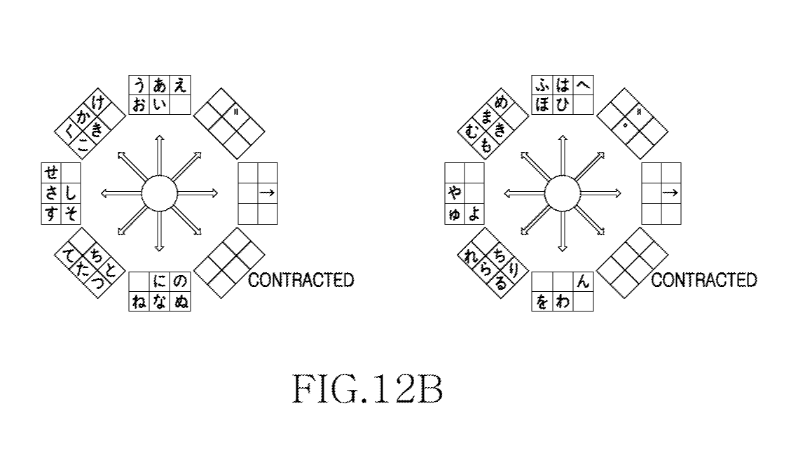

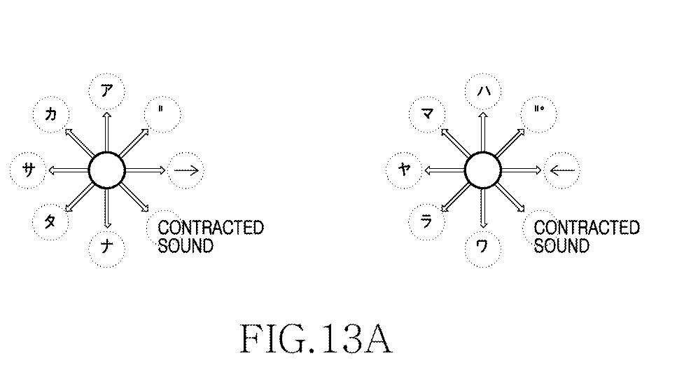

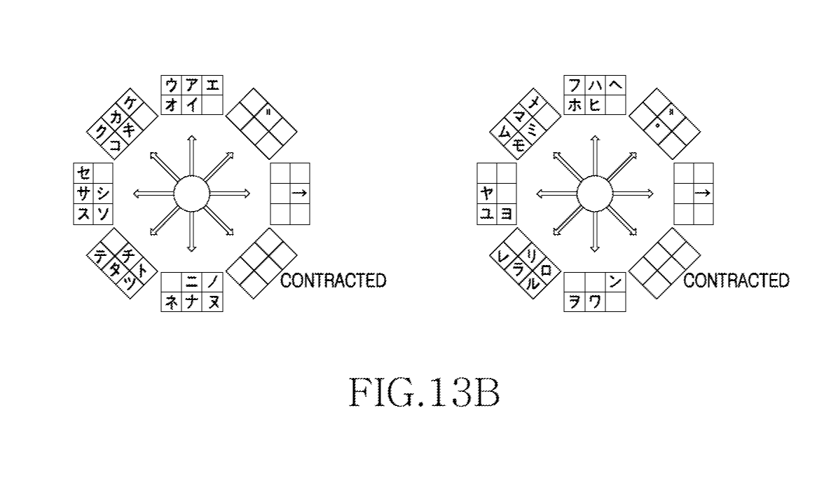

FIG. 1 is a block diagram illustrating a portable terminal according to an exemplary embodiment of the present invention. FIGS. 3A and 3B are diagrams illustrating numeral keyboards of a related portable terminal and a portable terminal according to an exemplary embodiment of the present invention. FIGS. 4A to 4C are diagrams illustrating a numeral input scheme in a portable terminal according to an exemplary embodiment of the present invention. FIG. 5 is a diagram illustrating a numeral input and a touch operation corresponding to the input numeral in a portable terminal according to an exemplary embodiment of the present invention. FIGS. 6A and 6B are diagrams illustrating an English keyboard of a portable terminal according to an exemplary embodiment of the present invention. FIGS. 9A and 9B are diagrams illustrating a Hangeul keyboard in a portable terminal according to an exemplary embodiment of the present invention, and FIG. 10 is a diagram illustrating an extended Hangeul keyboard in a portable terminal according to an exemplary embodiment of the present invention. FIGS. 12A and 12B are diagrams illustrating a Japanese keyboard in a portable terminal according to an exemplary embodiment of the present invention, and FIGS. 13A and 13B are diagrams illustrating a Japanese keyboard in a portable terminal according to an exemplary embodiment of the present invention.

Referring to FIG. 1, the portable terminal includes a touch screen 100, a controller 110, a touch signal receiver 120, and a memory unit 130.

The touch screen 100 includes a display unit 102 and a touch panel 104 installed above the display unit 102. Here, the display unit 102, which may be a Liquid Crystal Display (LCD), displays state information generated during operation of the portable terminal, a large amount of moving pictures, still pictures, and the like, under control of the controller 110. The display unit 102 also displays characters in peripheral regions centering on a position touched by a user under control of the controller 110. That is, the display unit 102 may display characters in peripheral regions that are several directions centering on the touched position. For example, displaying characters in peripheral regions that are eight directions centering on the touched position is described below. At this time, a user may set and change the peripheral directions in which the characters are displayed and the number of the peripheral directions. Also, the touch panel 104 recognizes an electrical analog signal dependent on a screen touch and forwards the recognized signal to the touch signal receiver 120.

The touch signal receiver 120 analyzes the electrical analog signal provided from the touch panel 104 included in the touch screen 100, and outputs position data dependent on a touched position of the screen to the controller 110.

The controller 110 controls and processes a general operation of the portable terminal. More particularly, the controller 110 includes a character User Interface (UI) controller 112 and thus, controls and processes a function for inputting a character according to a user's touch operation. The character UI controller 112 controls and processes a function for, when the touch screen is touched for character input, receiving touched position data from the touch signal receiver 120 and, according to a character input mode, displaying characters in the touched position and eight directions centering on the touched position. For example, as illustrated in FIG. 3B, in a numeral input mode, the display unit 102 displays numerals in a touched position and eight directions centering on the touched position under control of the character UI controller 112. At this time, the displayed numerals may be arranged in a similar form with numerals of a keypad of the related art as illustrated in FIG. 3A for convenience. Also, as illustrated in FIG. 6A or 6B, in an English input mode, the display unit 102 may display English characters in eight directions centering on a touched position under control of the character UI controller 112. Here, FIG. 6A illustrates a case where only representative English characters are displayed in eight directions centering on a touched position, and FIG. 6B illustrates a case where representative English characters and their sub characters are simultaneously displayed in eight directions centering on a touched position. At this time, the representative English characters may be determined based on the frequency of use. Also, in a Hangeul input mode, the display unit 102 may display characters as illustrated in FIG. 9A or 9B. In a Japanese input mode, the display unit 102 may display characters as illustrated in FIG. 12A or 12B or may display characters as illustrated in FIG. 13A or 13B, under control of the character UI controller 112. Here, FIGS. 12A and 12B illustrate ‘Hiragana’, and FIGS. 13A and 13B illustrate ‘Katakana’.

Also, the character UI controller 112 processes a function for detecting a drag (i.e., movement) of a touch occurring on the screen through position data received from the touch signal receiver 120 and inputting a numeral or character displayed in a corresponding direction. At this time, in a case where only representative characters are displayed in eight directions centering on a touched position, the character UI controller 112 displays sub characters of the representative characters displayed in the drag direction of the touch. The character UI controller 112 then determines a change or non-change of the drag direction of the touch and determines a character to input among the representative characters and the sub characters. Here, the character UI controller 112 may analyze the position data received from the touch signal receiver 120, thus determining a user's touch direction.

Also, the character UI controller 112 controls a function for character mode conversion or key conversion in the same character mode based on a touch scheme. For example, the character UI controller 112 performs a preset operation according to a touch scheme as shown in Table 1 below.

TABLE 1

| Touch scheme | Corresponding operation |
|---|---|
| [symbol] (long key) | Mode conversion |
| | (conversion between Hangeul/English/Japanese/numeral |
| | modes) |
| ◯ (circle key) | 1) ‘0’ (numeral mode) |
| | 2) Space (modes other than numeral mode) |
| • (short key) | 1) ‘5’ (numeral mode) |
| | 2) Key conversion |
| | (English capital [symbol] English lower case character, |
| | Hiragana [symbol] Katakana) |
| •• (double key) | Back space(delete) |

In Table 1, the [symbol] (long key)’ indicates that a character input mode is converted in a case where a screen touch is kept with no drag during a preset time. The ‘O (circle key)’ indicates that, in a case where a screen touch is made in a circle form in a numeral mode, ‘0 ’ is input and, in modes other than the numeral mode, it leaves a blank space and jumps as if a ‘space’ key was pressed. Also, the ‘ (short key)’ indicates that, in a case where a screen touch is made for a preset time or less in the numeral mode, ‘5 ’ is input and, in an English mode or Japanese mode, conversion between a capital character and a lower case character or between Hiragana and Katakana is made. The ‘ (double key)’ indicates that, in a case where a screen touch is made shortly continuously twice, a formerly input character is deleted as if a ‘Back space’ key was pressed.

The memory unit 130 includes a program memory, a data memory, a non-volatile memory, and the like, and stores a variety of programs and data for general operations of the portable terminal. More particularly, the memory unit 130 stores a format of keyboard configuration of each character input mode, and stores the touch scheme and operation information set according to the touch scheme as shown in Table 1 above.

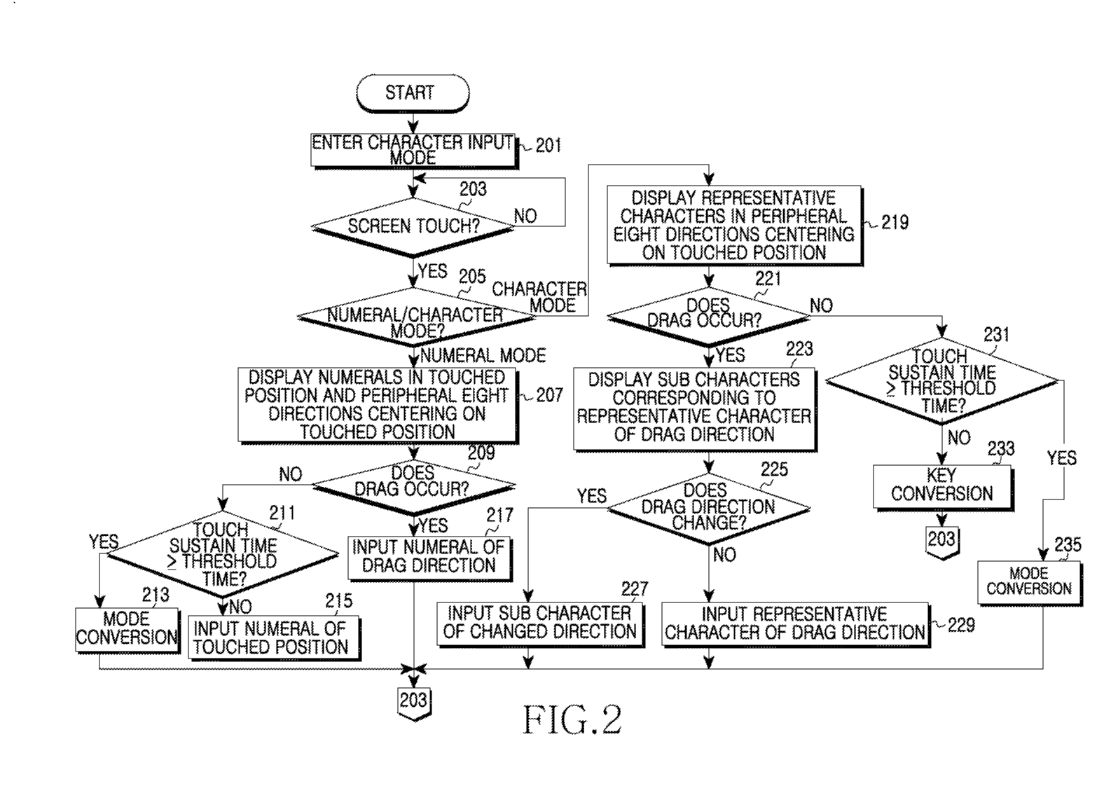

FIG. 2 is a flow diagram illustrating a character input procedure in a portable terminal according to an exemplary embodiment of the present invention.

Referring to FIG. 2, in step 201, the portable terminal enters a character input mode and, in step 203, the portable terminal determines if a screen is touched by a user. If the screen is touched by the user, the portable terminal determines if a current character input mode is a numeral mode or a character mode for inputting English, Hangeul, and Japanese in step 205.

If it is determined that the current character input mode is the numeral mode, the portable terminal displays numerals in a position in which the screen is touched and in peripheral eight directions centering on the touched position in step 207. At this time, the displayed numerals may be arranged in a similar form with numerals of a keypad of the related art as illustrated in FIG. 3A, for convenience of users accustomed to the keypad form of FIG. 3A. That is, as illustrated in FIG. 3B, the portable terminal displays a numeral ‘5’ in a position in which a touch screen is touched, and displays numerals ‘1’ to ‘9,’ other than the numeral ‘5,’ in its peripheral eight directions. At this time, instead of being displayed on the touch screen, a numeral ‘0’ is set to be input in a case where the touch screen is touched in a circle form as shown in Table 1.

Thereafter, in step 209, the portable terminal determines if a drag occurs with the touch being sustained. If it is determined that the drag occurs, in step 217, the portable terminal recognizes the direction in which the touch is dragged and inputs a numeral displayed in the drag direction and then, determines if a screen is touched by a user in step 203. For example, after a screen is touched by a user as illustrated in FIG. 4A, when drag occurs in the direction of ten o'clock as illustrated in FIG. 4B, the portable terminal may input numeral ‘1’ displayed in the drag direction as illustrated in FIG. 4C. At this time, the portable terminal may give a highlight effect (e.g., size, thickness, or color change, underline or figure addition) to the numeral ‘1’ in order to illustrate the input of the numeral ‘1’, and give a non-highlight effect (e.g., size, thickness, or color change, deletion, or dotted-line indication) to the remaining numerals. Also, when drag occurs in any one of eight directions as illustrated in FIG. 4B, the portable terminal may formerly give the highlight effect to a numeral corresponding to the drag direction in order to prevent drag from occurring in the direction unintended by a user.

If it is determined that the drag does not occur in step 209, the portable terminal determines if the touch is sustained during a period that is equal to or greater than a threshold time in step 211. If it is determined that the touch is sustained during the period that is equal to or greater than the threshold time, the portable terminal converts the character input mode in step 213. That is, the portable terminal converts the numeral mode into one of a Hangeul mode, an English mode, and a Japanese mode. On the other hand, if it is determined that the touch is not sustained during the period that is equal to or greater than the threshold time, the portable terminal inputs a numeral of the touched position (i.e., numeral ‘5’) in step 215 and then, the portable terminal determines if a screen is touched by a user in step 203.

Here, in a case where the portable terminal inputs a numeral according to a touch operation as described above, a user may input numerals by performing touch operations as illustrated in FIG. 5.

On the other hand, if the current character input mode is a character mode, i.e., any one of the English mode, the Hangeul mode, and the Japanese mode in step 205, the portable terminal displays corresponding characters in peripheral eight directions centering on a position in which a screen is touched in step 219. For example, when the character mode is in the English mode, as illustrated in FIG. 6A, the portable terminal may display English characters determined as representative characters in eight directions centering on a touched position. Here, the displayed representative characters of FIG. 6A are determined based on the frequency of use. In more detail, after the portable terminal divides alphabet characters ‘A’ to ‘Z’ into four-element groups ‘A’ to ‘D’, ‘E’ to ‘H’, ‘I’ to ‘L’, ‘M’ to ‘P’, ‘Q’ to ‘T’, and ‘U’ to ‘X’ and a group ‘Y’ to ‘Z’, the portable terminal determines a character having the highest frequency of use in each group, as a representative character, and determines the remaining characters of each group as sub characters. Also, when the character mode is in the Hangeul mode, the portable terminal displays a Hangeul keyboard as illustrated in FIG. 9A. When the character mode is in the Japanese mode, the portable terminal displays a Japanese keyboard as illustrated in FIG. 12A or FIG. 13A. The Japanese mode may determine [symbol] -level characters as representative characters.

Thereafter, in step 221, the portable terminal determines if drag occurs with the touch being sustained. If it is determined that the drag does not occur in step 221, the portable terminal determines if the touch is sustained during a period that is equal to or greater than the threshold time in step 231. If it is determined that the touch is sustained during the period that is equal to or greater than the threshold time, the portable terminal converts the character input mode in step 235. For example, when the character input mode is in the English mode, the portable terminal converts the English mode into any one of the Hangeul mode and the Japanese mode. On the other hand, if it is determined that the touch is not sustained during the period that is equal to or greater than the threshold time, the portable terminal performs key conversion in a corresponding character input mode in step 233. In more detail, in a case where a current character input mode is in the English mode and a key mode is a capital English character, the portable terminal converts the key mode from the capital English character to a lower case English character. In a case where the current character input mode is in the Japanese mode and the key mode is Hiragana, the portable terminal converts the key mode from Hiragana to Katakana. In a case where the current character input mode is in the Hangeul mode, the portable terminal will perform no conversion. Thereafter, the portable terminal determines if a screen is touched by a user in step 203.

On the other hand, if it is determined that the drag occurs in step 221, in step 223, the portable terminal recognizes the direction in which the touch is dragged, identifies sub characters of a representative character displayed in the drag direction, and displays the sub characters around the representative character. Here, the sub characters of the English mode, the Hangeul mode, and the Japanese mode may be arranged as illustrated in FIG. 6B, FIG. 9B, and FIGS. 12B and 13B, respectively. An arrangement of sub characters of each character input mode is described below.

The English mode groups alphabet characters ‘A’ to ‘Z’ into four-element groups ‘A’ to ‘D’, ‘E’ to ‘H’, ‘I’ to ‘L’, ‘M’ to ‘P’, ‘Q’ to ‘T’, and ‘U’ to ‘X’ and a group ‘Y’ to ‘Z’, determines a character having the highest frequency of use in each group as a representative character, and determines the remaining characters as sub characters. Also, the Hangeul mode configures sub characters by characters expressible by adding one or more strokes to a representative character and fortis characters of the characters. For example, in a case where a representative character is [symbol] as illustrated in FIG. 9B, [symbol] or [symbol] may be expressed by adding one or more strokes to the [symbol] and there is [symbol] as a fortis character of the [symbol] , so the Hangeul mode configures sub characters of the [symbol] by the [symbol] , [symbol] , and [symbol] . At this time, there are exceptional characters (e.g., [symbol] [symbol] ) not expressible by stroke addition or fortes. Thus, the Hangeul mode may configure sub characters as illustrated in FIG. 10. Also, as illustrated in FIGS. 12B and 13B, the Japanese mode may configure representative characters by a [symbol] level, Dakuten ( [symbol] ) for conversion into a voice sound, a symbol for conversion into a contracted sound, sub characters by a [symbol] level, a [symbol] level, a [symbol] level, a [symbol] level, and Handakuten) (°) for conversion into a p-sound. Here, when a screen is touched by a user, the portable terminal displays several representative characters centering on a touched position and, in a case where drag occurs with the screen being touched, the portable terminal displays the representative character of the drag direction and its sub characters. However, when the screen is touched, the portable terminal may display all of the representative characters and the sub characters centering on the touched position.

Thereafter, as illustrated in FIG. 2, the portable terminal determines if the drag direction changes in step 225. If it is determined that the drag direction does not change, the portable terminal inputs a representative character of the drag direction in step 229. If it is determined that the drag direction changes, the portable terminal inputs a sub character displayed in a changed direction in step 227 and then, the portable terminal determines if a screen is touched by a user in step 203.

An example of, when the character input mode is a character mode, inputting English, Hangeul, and Japanese letters is described below.

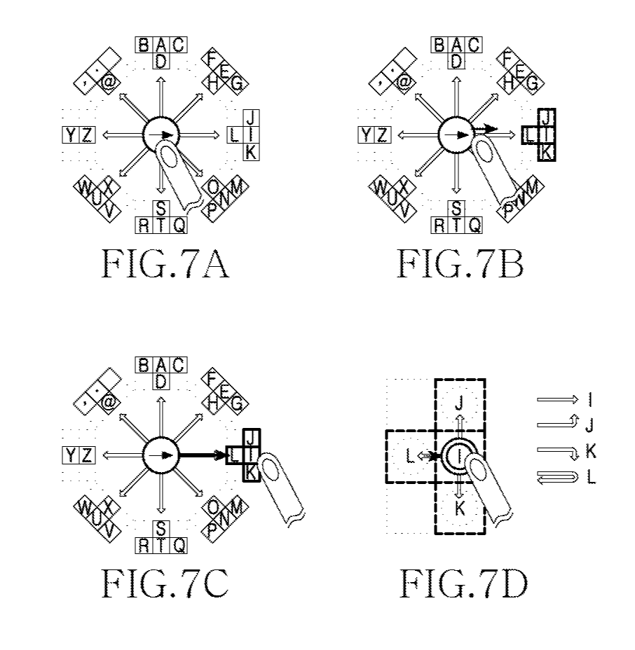

FIGS. 7A to 7D are diagrams illustrating an English character input scheme in a portable terminal according to an exemplary embodiment of the present invention.

Referring to FIGS. 7A to 7D, in an English mode, a screen is touched by a user as illustrated in FIG. 7A. When drag occurs in the direction of 3 o'clock as illustrated in FIG. 7B, the portable terminal highlights a representative character ‘I’ of the drag direction and sub characters ‘J’, ‘K’, and ‘L’ as illustrated in FIG. 7C, and inputs one of the ‘I’, ‘J’, ‘K’, and ‘L’ according to a change or non-change of the drag direction as illustrated in FIG. 7D. Here, when the drag direction is maintained, the portable terminal inputs the representative character ‘I’ and, when the drag direction changes upward, the portable terminal inputs the sub character ‘J.’ When the drag direction changes downward, the portable terminal inputs the sub character ‘K’ and, when the drag direction changes in an opposite direction, the portable terminal inputs the sub character ‘L’. Here, the portable terminal may formerly give a highlight effect (e.g., size, thickness or color change, underline or figure addition) to the characters ‘I’, ‘J’, ‘K’, and ‘L’ corresponding to the drag directions, thus preventing the drag from occurring in the direction unintended by a user. In order to represent an input character, the portable terminal may give the highlight effect (e.g., size, thickness or color change, underline or figure addition) to the input character, and give a non-highlight effect (e.g., size, thickness or color change, deletion, or dotted-line indication) to the remaining characters.

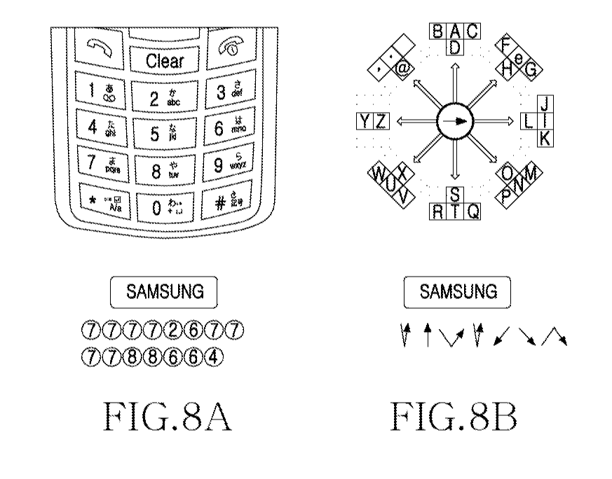

FIGS. 8A and 8B are diagrams illustrating an English input and a touch operation corresponding to the English input in a portable terminal according to an exemplary embodiment of the present invention.

Referring to FIG. 8A, in a case where a user intends to input a word ‘SAMSUNG’, a scheme using a keypad of the related art has to perform fifteen key inputs. On the contrary, in an exemplary implementation, a scheme using the touch operation in a portable terminal as described above for inputting the word ‘SAMSUNG’ requires seven touch inputs.

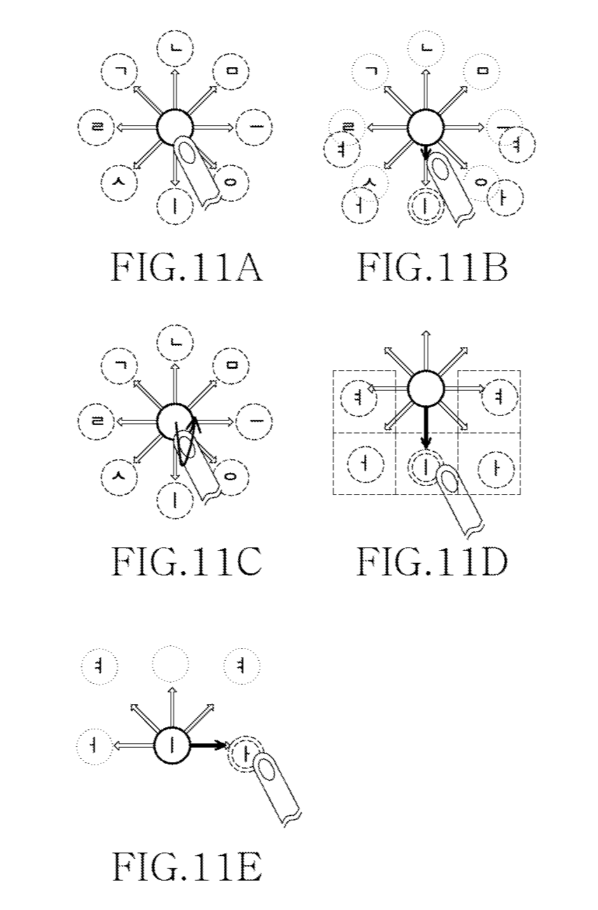

FIGS. 11A to 11E are diagrams illustrating a Hangeul character input scheme in a portable terminal according to an exemplary embodiment of the present invention.

Referring to FIGS. 11A to 11E, in a Hangeul mode, a screen is touched by a user as illustrated in FIG. 11A. When drag occurs in the direction of 6 o'clock as illustrated in FIG. 11B and the drag returns to the original position with no occurrence of drag of a preset distance or more as illustrated in FIG. 11C, the portable terminal does not input a character of the drag direction and returns to the same state as when the user touches an initial screen. If drag occurs again by a preset distance or more in the direction of 6 o'clock by the user, the portable terminal displays a representative character of the drag direction and sub characters as illustrated in FIG. 11D. Here, if the drag direction does not change, the portable terminal inputs a representative character ‘I’ as illustrated in FIG. 11D and, if the drag direction changes to the right, the portable terminal inputs a sub character [symbol] as illustrated in FIG. 11E.

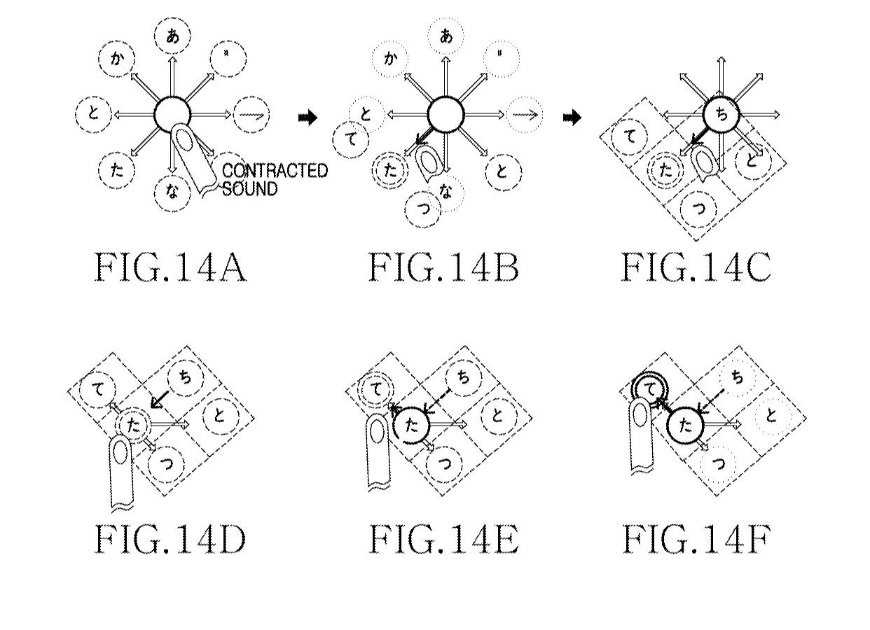

FIGS. 14A to 14F are diagrams illustrating a Japanese character input scheme in a portable terminal according to an exemplary embodiment of the present invention.

Referring to FIGS. 14A to 14E, in a Japanese mode and a Hiragana input state, a screen is touched by a user as illustrated in FIG. 14A and then, if drag occurs in the direction of seven o'clock as illustrated in FIG. 14B, the portable terminal simultaneously displays a Hiragana representative character of the drag direction and a Katakana representative character. At this time, if the drag occurs by a preset distance or more, as illustrated in FIG. 14C, the portable terminal displays only the Hiragana representative character. In FIGS. 14D, 14E, and 14F, the portable terminal highlights the Hiragana representative character or its sub characters in accordance with a change of the drag direction to illustrate a character to be input according to the drag direction, and inputs a corresponding character.

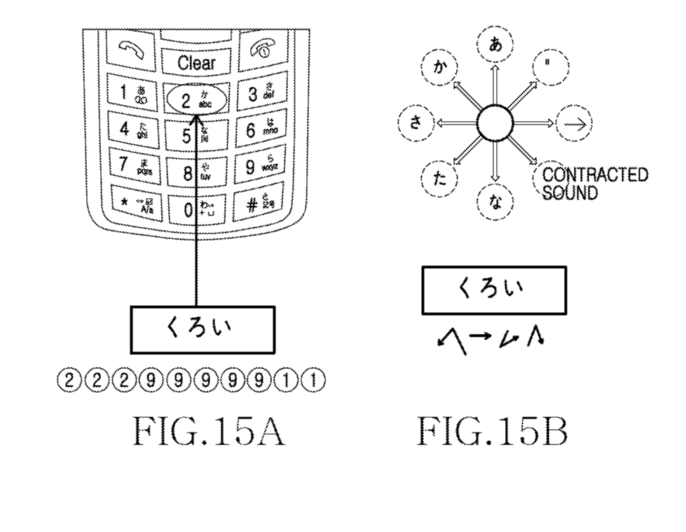

FIGS. 15A and 15B are diagrams illustrating Japanese character input schemes in a portable terminal of the related art and a portable terminal according to an exemplary embodiment of the present invention.

Referring to FIGS. 15A and 15B, in a case where a user intends to input a word [symbol] , a character input scheme using a keypad of the related art requires ten key inputs. On the contrary, in an exemplary implementation, a scheme using the touch operation in a portable terminal as described above for inputting the word [symbol] [symbol] requires four touch inputs.

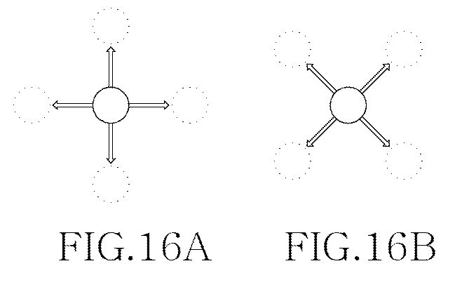

FIGS. 16A and 16B are diagrams illustrating an input scheme for recognition rate extension in a portable terminal according to an exemplary embodiment of the present invention.

In the above description, when a screen is touched, a portable terminal displays characters in eight directions centering on a touched position. Without displaying the characters in the eight directions at one time, as illustrated in FIGS. 16A and 16B, the portable terminal may display characters only in four directions at one time based on an input of a side key (→) thus increasing a recognition rate. In more detail, if the screen is first touched, the portable terminal displays characters in four directions as illustrated in FIG. 16A and then, if a side key is input, the portable terminal displays other characters in other four directions as illustrated in FIG. 16B, thereby being capable of widening a touch region of each direction to improve a recognition rate.

In the exemplary embodiments of the present invention, by inputting a character according to the direction in which a touch screen is touched, character input is possible although a user does not touch a defined region. Because the user may input a character by a simple direction turn, the character input does not require several touch inputs and increased speed input is possible. Also, by arranging a keyboard based on existing Hangeul, English, and Japanese systems, a user may easily learn the keyboard.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for character input using a touch screen in a portable terminal, the method comprising:
when a screen is touched, determining a character input mode;
displaying characters of the determined character input mode in peripheral regions centering on a touched position; and
inputting a character positioned in a direction in which the touch is dragged.

2. The method of claim 1, wherein the character input mode comprises at least one of a numeral mode, an English mode, a Hangeul mode, and a Japanese mode.

3. The method of claim 2, wherein, when the character input mode is the numeral mode, a number is displayed in the touched position.

4. The method of claim 2, wherein, when the character input mode is any one of the English mode, the Hangeul mode, and the Japanese mode, the displaying of the characters comprise:
displaying representative characters of a corresponding character input mode in peripheral regions that includes four or eight directions centering on the touched position; and
when the touch is dragged, additionally displaying sub characters of the representative character positioned in the drag direction.

5. The method of claim 2, wherein, when the character input mode is any one of the English mode, the Hangeul mode, and the Japanese mode, the displaying of the characters comprise:
grouping and displaying characters of a corresponding character input mode in peripheral regions that include four or eight directions centering on the touched position.

6. The method of claim 2, wherein, when the touch is sustained in a state of no drag during a period that is at least one of equal to and greater than a threshold time, the character input mode changes.

7. The method of claim 6, wherein, when the touch is not sustained in a state of no drag during a period that is at least one of equal to and greater than a threshold time, a key mode changes.

8. The method of claim 1, further comprising highlighting a character positioned in the direction in which the touch is dragged,
wherein the highlighting uses at least one of a size change of a character, a thickness change, a color change, underline addition, and figure addition.

9. The method of claim 1, further comprising non-highlighting a character not positioned in the direction in which the touch is dragged,
wherein the non-highlighting uses at least one of a size change of a character, a thickness change, a color change, deletion, and dotted-line indication.

10. An apparatus for character input using a touch screen in a portable terminal, the apparatus comprising:
a touch screen for detecting a touch by a user and displaying a character; and
a controller for, when a screen is touched, determining a character input mode and display characters of the determined character input mode in peripheral regions centering on a touched position, and for controlling to input a character positioned in a direction in which the touch is dragged.

11. The apparatus of claim 10, wherein the character input mode comprises at least one of a numeral mode, an English mode, a Hangeul mode, and a Japanese mode.

12. The apparatus of claim 11, wherein, when the character input mode is the numeral mode, the controller controls to display a number in the touched position.

13. The apparatus of claim 11, wherein, when the character input mode is any one of the English mode, the Hangeul mode, and the Japanese mode, the controller controls to display representative characters of a corresponding character input mode in peripheral regions that include four or eight directions centering on the touched position and, when the touch is dragged, controls to additionally display sub characters of the representative character positioned in the drag direction.

14. The apparatus of claim 11, wherein, when the character input mode is any one of the English mode, the Hangeul mode, and the Japanese mode, the controller groups and displays characters of a corresponding character input mode in peripheral four or eight directions centering on the touched position.

15. The apparatus of claim 11, wherein, when the touch is sustained in a state of no drag during a period that is at least one of equal to and greater than a threshold time, the controller changes the character input mode.

16. The apparatus of claim 15, wherein, when the touch is not sustained in a state of no drag during a period that is at least one of equal to and greater than a threshold time, a key mode changes.

17. The apparatus of claim 10, wherein the controller highlights a character positioned in the direction in which the touch is dragged, and
wherein the highlighting uses at least one of a size change of a character, a thickness change, a color change, underline addition, and figure addition.

18. The apparatus of claim 10, wherein the controller non-highlights a character not positioned in the direction in which the touch is dragged, and
wherein the non-highlighting uses at least one of a size change of a character, a thickness change, a color change, deletion, and dotted-line indication.
